(19) United States
(12) Patent Application Publication
(10) Pub. No.: US 2014/0316546 A1
(43) Pub. Date: Oct. 23, 2014

(54) Method And System For Direct Additive Manufacturing From An Advertisement

(71) Applicant: BLACKNIGHT HOLDINGS, LLC, PLAINFIELD, IL (US)

(72) Inventors: Ryan Walsh, Aurora, IL (US); Alex J. Falesch, Oswego, IL (US)

(21) Appl. No.: 14/027,035

(22) Filed: Sep. 13, 2013

Related U.S. Application Data
(60) Provisional application No. 61/813,611, filed on Apr. 18, 2013.

(51) Int. Cl. G06F 17/50; G06Q 20/40

(52) U.S. Cl. CPC G06F 17/50; G06Q 20/40
USPC 700/98

(57) ABSTRACT

A method and system form physical objects from digital files generated from transactions carried out on internet enabled devices. The system comprises: (a) an internet enabled device capable of receiving an advertised offer and transmitting communications from a user regarding a purchase based upon the advertised offer; (b) a digital rendering device capable of forming a physical object from a digital file containing user specified instructions; (c) a vendor capable of receiving information regarding the purchase and providing the digital file in a downloadable format; (d) a payment processor capable of (i) receiving monetary funds transfer authorization from the user, (ii) effecting the monetary funds transfer, (iii) issuing a communication to the vendor when the monetary funds transfer is successfully effected, and (iv) transferring at least a portion of the monetary funds to the vendor. The digital rendering device can be a three-dimensional printer or an additive manufacturing device.

### CROSS-REFERENCE TO RELATED APPLICATION

This application is related to and claims priority benefits U.S. Provisional Patent Application Ser. No. 61/813,611 filed on Apr. 18, 2013, entitled “System And Method For Forming A Physical Object From A Digital File Generated From A Transaction Carried Out On An Internet Enabled Device”. The '611 provisional application is hereby incorporated by reference herein in its entirety.

### FIELD OF THE INVENTION

The present application relates to direct additive manufacturing. In particular, the present application relates to a method and system for forming a physical object from a digital file generated from a transaction carried out on an internet enabled device.

### BACKGROUND OF THE INVENTION

Additive manufacturing devices, otherwise known as three-dimensional (3D) printing devices, are becoming more cost effective and are showing expansion of usage consistent with previous economic models involving technological advances in both printing and manufacturing hardware. The proliferation of this technology is now bringing the messages and capabilities of marketing and advertising specialists to the forefront of a majority of consumers. With global information and communication being within the capabilities of most every household and business, it would be a logical step in the evolution to have manufacturing added into those capabilities. The present method and system provide techniques to facilitate the link between advertising and additive manufacturing.

Costs have fallen sharply since the introduction of additive manufacturing, which will likely become a staple appliance in most households in the coming years. Much like previous technological innovations that have revolutionized households, such as refrigerators, air conditioners, and the personal computer, 3D printing will likely change the way household items and daily goods are purchased, shipped and manufactured. The ability to create goods as limitless as the imagination will likely be within the capability of every business and household that owns a 3D printer. Many companies and firms will create business models solely based on this single technological advancement, whether it is manufacturing the device, servicing the device, or providing refills for the additive materials. Much like the evolution of the home printer from the typewriter, and the fax machine evolving into email, additive manufacturing will likely become affordable to most consumers and businesses.

Additive manufacturing has been used for a variety of purposes across a vast spectrum of end uses, especially in a commercial environment to increase speed, quality and customization of what were once very time-consuming and resource-consuming applications. Applications have included rapid prototyping, design visualization, metal casting, geospatial engineering, medical and healthcare related applications, educational applications, as well as entertainment-oriented applications. This can include creating small components to repair structures where distant manufacturing and shipping would be too expensive, such as space-based applications or deep water applications. Prosthetic makers can now create prosthetic appliances that can be custom-fit, designed, prototyped and manufactured within a single location and in under a day. This type of technology could benefit numerous veterans, those in active military service and refugees. Another foreseeable application for 3D printing is the testing and reengineering of the mechanical and physical properties of a new prototype for fractions of the costs incurred using traditional subtractive means of manufacturing. This technology will in turn benefit both company shareholders and their customers by reducing research and development expenditures. 3D printing technology will also enable lower barriers to entry for innovators who wish to procure detailed and accurate prototypes.

Current use of 3D printing is driven by enthusiasts, academics, and early adopters mainly in hobbyist, educational and experimental forms. Presently, simple functional objects are already available for users to manufacture themselves, such as coat hooks, backscratchers, accessories for other objects like phone cases, watch bands, ornamental art pieces, or even replacement parts for existing household items like appliances. Many businesses are also developing manufacturing process to print food; the most successful attempts with chocolate and gelatins, with NASA recently investing in a pizza making printer. With more complex designs and uses being created, tested and shared, the ways in which this technology will adapt to our various household needs are endless.

Extrusion and fused deposition modeling (FDM) works by laying down material in layers with plastic filament or metal wire fed into heated nozzle. Wire or electron beam freeform fabrication (EBF), which is designed for building in zero gravity environments, uses an electron beam and a solid wire feedstock to fabricate metallic structures. Granular, DMLS (direct metal laser sintering), EBM (electron beam melting), SHS (selective heat sintering), SLS (selective laser sintering), or powder and plaster based 3D printing (powder bed and inkjet head 3D printing) use a high-powered laser to melt-build from granular or powdered materials inside the build chamber area layer by layer, the leftover material then being separated to be discarded or saved for use later. Laminated object manufacturing (LOM) builds using sheets glued together after being cut with a knife or laser cutter. Light polymerized, stereolithography (SLA) uses a liquid vat of curable photopolymer resin and an ultraviolet laser to build layer by layer.

The most advantageous techniques for 3D printing are extrusion and granular due to the variety of buildable materials that can be employed in each of these techniques. Extrusion is the simplest to use while still allowing a variety of materials to be printed. Whether it is plastics, metals or edible materials, these techniques currently offer the most flexibility for objects to be printed.

Stereolithography is now considered to provide the greatest accuracy and better surface finish than other techniques. Other research is being devoted to using similar techniques for tissue engineering and for repair or replacement for portions of whole body tissues such as bone, cartilage, skin, muscle, or blood vessels. Recent research has also shown it is possible to use 3D printing techniques to create chemical compounds by first printing a reaction vessel and then carrying out the chemical reaction in those vessels. The most likely outcome will be a hybrid of the most well-rounded and versatile techniques, to allow the most freedom of design for objects to be manufactured.

Another technology that has already become ubiquitous involves smart network-enabled devices. Smart devices are becoming so prevalent in society that most individuals own multiple smart or internet enabled devices.

Most existing 3D printing hardware and software can customize objects across three dimensions to include base, width and height. The objects can be modified according to the end user's needs. The process involved in making the final object rendered by 3D printing will typically fall into one of four categories:

Standard. A standard object is one that will be advertised and shown as-is. An example of a standard object would be a series of action figures. Each model of action figure in the product line is offered as is, with no customization. Current manufacturing models can be considered standard models in most instances. Each one is a licensed object to the copyright holder and is to be sold and advertised without customization or modifications.

Semi-standard. A semi-standard object is one that varies slightly from the original design. However, each semi-standard product has the same basic functions as the original object. An example of a semi-standard object is a set of dinnerware, where there is a base model and where the customer can select various colors or patterns to suit their desires. The final rendering is discernible from the original licensed product only in minor aesthetic details.

Semi-custom. A semi-custom object is one in which there is a base object that can be customized within a specific set of criteria by the user. However, the parameters of customization of a semi-custom object are limited in scope. One example of a semi-custom object would be culinary additive manufacturing for a pizza, for example. The user would choose a pizza but have the option to add a number of toppings that are available to the hardware/process. The varying outputs with different types and amounts of toppings would not necessarily resemble other objects being rendered from the same process/hardware.

Custom. A custom object is an object in which the end user can modify a large number of parameters and specifications to meet their needs or desires. Users can modify essentially any aspect of a custom object to the point where the object no longer resembles the original object from which the custom object is derived.

The present method and system are best suited to making the standard category of rendered objects, particularly in the instance of a licensed figure being advertised to be 3D printed. The present method and system are also suited to the semi-standard category, in which the fundamental design of an object is modified in minor respects, as well as the semi-custom category as in the examples set forth above. The present method and system is not particularly well-suited to the custom category of rendered objects, as in the case of rapid prototyping, biomedical treatments designed specifically for individual patients, as well as hobby enthusiast and recreational designers.

### Description of Related Prior Art References

Some existing 3D printing techniques could be used in a manner complementary, or in conjunction with, the method and system. Others describe the framework and infrastructure for the described advertisement or transaction to take place. Exemplary of such techniques are described in the following references.

Kaltenbach U.S. Patent Application Publication No. US2010/0088650A1 is directed to a kiosk/vending machine in a commercial/retail location at which the printed object is to be rendered. Kaltenbach's device can be used in lieu of a privately owned 3D printer, for example. Kaltenbach's outsourcing of the actual rendering to a third party contrasts with the present method and system, which focuses on the advertising aspect to facilitate a purchase of a rendered object more than the actual end uses or logistics of the hardware involved. By providing a vestibule/kiosk/retail location, Kaltenbach provides a way for customers to outsource their 3D printing hardware, which would complement the present method and system by providing a greater number of users with the ability to render objects at a nearby commercial or retail location.

Abraham U.S. Patent Application Publication No. US2008/0111816A1 describes a technique similar Kaltenbach's discussed above. Abraham's technique employs a retail location as an outsourced 3D printing provider, thereby allowing additive manufacturing to reach a larger number of users. Abraham's technique establishes an online portal to both customize and create objects. Providing a portal for customization and rendering is different from and complementary to the present method and system.

Norman U.S. Patent Application Publication No. US2011/0313878A1 describes a portal system website which essentially allows users to customize, change and view their 3D objects, and also allows users to order and ship as a brokerage for 3D designs. Once again, Norman's technique differs from but is complementary to the present method and system. In this regard, Norman's technique can provide semi-customization minor customizations to semi-standard objects rendered using the present method and system.

Vos Netherlands Patent No. 1036449C describes a portal system used in the customization, brokerage and database management of 3D printing files and designs. Vos's technique thus differs from the present method and system, which involve advertising that prompts customer action.

Plattsmier U.S. Patent Application Publication No. US2012/0221433A1 describes a 3D printing technique that employs a web portal to a digital location where a user can search, view and analyze in detail the parameters of an object. Users can then purchase a 3D rendered object through an online marketplace within Plattsmier's digital interface. Plattsmier thus establishes an ongoing digital marketplace as opposed to the present method and system, which involves a single transaction for each advertisement presented to a potential customer of a 3D printed object.

Banerjee U.S. Patent Application Publication No. US2002/0188518A1 describes a business to business brokerage for mass customization of 3D designs and allows for the large-order manufacture of specific custom designs. By contrast, the present method and system involves the advertising of licensed goods to be rendered privately after an interaction prompted by an unsolicited advertisement.

Pettis U.S. Patent Application Publication No. US2012/0113473A1 is a general background reference that describes the networking of additive manufacturing machines and frames the necessary communication and exchanges of information to allow files to be transferred from beyond the hardware to a format that allows multiple machines to operate as one.

Within Technologies International Publication No. WO2012/146943A2 is a general background reference that describes improvements to 3D design and manufacturing systems, including an authentication technique for 3D designs.

Amazon U.S. Pat. No. 5,960,411A describes a technique for authentication, customer identification, creation of a shopping cart, and a mechanism for exchanging information to facilitate an online transaction. The Amazon one-click technique could be used complementarily with the present method and system, which involve a single transaction for each advertisement presented to a potential customer of a 3D printed object.

### SUMMARY OF THE INVENTION

A system forms physical objects from digital files generated from transactions carried out on an internet enabled devices. The system comprises:
(a) an internet enabled device capable of receiving an advertised offer and transmitting communications from a user regarding a purchase based upon the advertised offer;
(b) a digital rendering device capable of forming a physical object from a digital file containing user specified instructions;
(c) a vendor capable of receiving information regarding the purchase and providing the digital file in a downloadable format;
(d) a payment processor capable of (i) receiving monetary funds transfer authorization from the user, (ii) effecting the monetary funds transfer, (iii) issuing a communication to the vendor when the monetary funds transfer is successfully effected, and (iv) transferring at least a portion of the monetary funds to the vendor.

In one system embodiment, the digital rendering device is a three-dimensional printer. In another system embodiment, the digital rendering device is an additive manufacturing device.

The system can further comprise a data storage device capable of storing the digital file for a period of time until the user releases the digital file from the data storage device to commence formation of the physical object. The data storage device can reside within the digital rendering device or it can be cloud-based.

The digital file can be sequenced with other digital files to commence formation of the physical object once other physical objects have been formed using the other digital files.

A method of forming a physical object from a digital file generated from a transaction carried out on an internet enabled device, the method comprising:
(a) receiving an advertised offer from a vendor on an internet enabled device;
(b) transmitting communications from a user regarding a purchase based upon the advertised offer;
(c) receiving authorization from the user for the transfer of monetary funds;
(d) effecting the monetary funds transfer;
(e) issuing a communication to the vendor when the monetary funds transfer is successfully effected;
(f) providing the digital file in a downloadable format to the user;
(g) delivering the digital file to digital rendering device;
(h) effecting formation of a physical object by the digital rendering device using instructions contained in the digital file;
(i) transferring at least a portion of the monetary funds to the vendor.

In one method embodiment, the digital rendering device is a three-dimensional printer. In another method embodiment, the digital rendering device is an additive manufacturing device.

The method can further comprise storing the digital file in a data storage device for a period of time until the user releases the digital file from the data storage device to commence formation of the physical object. The data storage device resides within the digital rendering device. The data storage device can also be cloud-based.

The method can further comprise sequencing the digital file with other digital files to commence formation of the physical object once other physical objects have been formed using the other digital files

### BRIEF DESCRIPTION OF THE DRAWINGS

FIG. 1 is a sequence diagram of the present method and system, beginning with the customer accessing or using content in which an advertisement is witnessed through the actual rendering of the object.

FIG. 2 is a sequence diagram that is similar to FIG. 1, however without the added preface of content being viewed prior to the unsolicited advertisement being witnessed.

FIG. 3 is a graphical representation of the user interaction with an advertised offer, in which a user becomes a customer upon a successful purchase.

FIG. 4 is a graphical representation of the user interacting with a web portal for the present method and system.

FIG. 5 illustrates the steps involved in an economic transaction and describes the fiduciary and service obligations of the parties involved in the transaction.

FIG. 6A illustrates the process of forming a physical object from a digital file.

FIG. 6B is the graphical representation of steps in FIG. 6A.

FIG. 7 illustrates a digital file being processed through additive manufacturing to render a physical object.

### DETAILED DESCRIPTION OF PREFERRED EMBODIMENT(S)

In the context of this disclosure and description of the present method and system, the following terms are defined as follows:

3D printing or additive manufacturing: A process of forming a three-dimensional tangible solid object from a digital file. 3D printing is achieved using an additive process, in which successive layers of material are laid down or melted together in various shapes, functions and formats. A 3D printer is a device using additive manufacturing that takes a digitally formatted file and renders a three-dimensional physical object of the specifications embedded in the file.

Immediate manufacturing: A process in which a digital file is purchased and upon a completed transaction, either the file is downloaded and immediately rendered by the 3D printer subject to the various component capacities and capabilities of the hardware or the file is placed in a queue to await manufacturing at the convenience of the purchaser.

Object: A three-dimensional rendering of a specified design that is the resulting output of a 3D printer or additive manufacturing process.

Advertisement: An interactive media, by means of a button or command prompt, in which a user is influenced to make a subsequent purchase and download of a file format necessary or desirable for 3D printing and the rendering of the file to a form a physical object by the process of additive manufacturing. Both dynamic advertisements, such as commercials; and static advertisements, such as banner ads, are both considered applicable advertisements for this method and process described within this embodiment.

Smart interface: A smart-capable or internet-enabled device that displays advertisements to a user, has the capability of downloading a renderable file, and communicates indirectly through any means of data transfer to a 3D printer. Examples of smart or internet-enabled devices are smart televisions, smart phones, tablets, laptops, computers, worn smart devices or other augmented reality devices, e-readers, wireless capable MP3 devices or digital music player, vehicle-based interactive devices, digital catalogs, smart glass, and any other smart capable device.

Third party payment processor: A third party that facilitates a purchase or transaction by processing funds and/or transferring funds from the purchaser to the seller. However, the manufacturer, advertiser and/or seller could be acting as the role of third party processor, and does not necessarily imply an outsourced vendor.

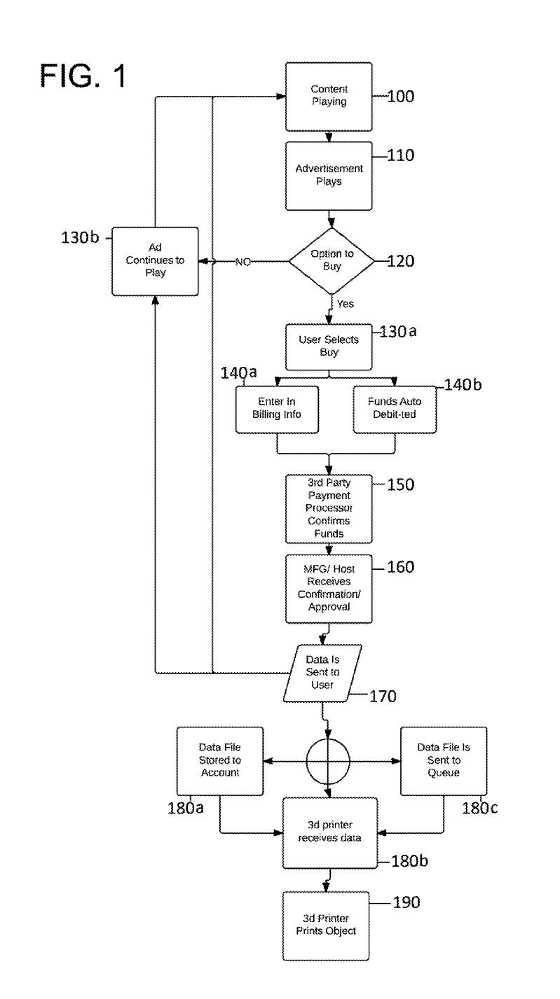

Turning first to FIG. 1, interaction with a potential customer/user begins when the customer/user is searching for content or using content on the internet or other network (step 100). The customer/user witnesses an unsolicited advertisement in which the object advertised has the ability to be rendered using a 3D printer (step 110). The customer is given the option to buy the object by means of digital file in which they would be able to render it using their privately owned additive manufacturing device (step 120). If the user declines the purchase and would like to continue interacting with the content (step 130b), the advertisement will finish playing, or if finished, return the user back to (step 100).

If the user elects to become a customer by purchasing the file/object, the user/customer shall select the “Buy” or “Purchase” or “Print Now” button option, for example. However, any button or prompt that furthers the purchase is included in step 130a. Following the customer's consent to purchase, the customer will proceed with standard purchase procedure in which they will enter their customer information, such as customer account number, billing information, customer identification number and the like (step 140a), as well as funds being debited from the given billing information which fulfills the customer responsibilities of the purchase (step 140b).

The third party payment processor will confirm the funds are available (step 150), and sends an approval/confirmation of payment (step 160). The data or file is then transferred to the user, fulfilling the responsibilities of the provider/manufacturer/designer/host, which is the final consummation of the transaction (step 170). The customer is then given the option to be redirected back to their choice of content or resume actions listed (step 100).

Once the customer has possession of the file/data to be rendered, it is either stored in the customer's account to await further transfer to the 3D printer or appropriate additive manufacturing device or software interface for the device (step 180a), or the file/data is sent to a queue within the software or device to await manufacture (step 180c). The 3D printer then receives the information (step 180b), and then renders the object according to the specifications of the file (step 190).

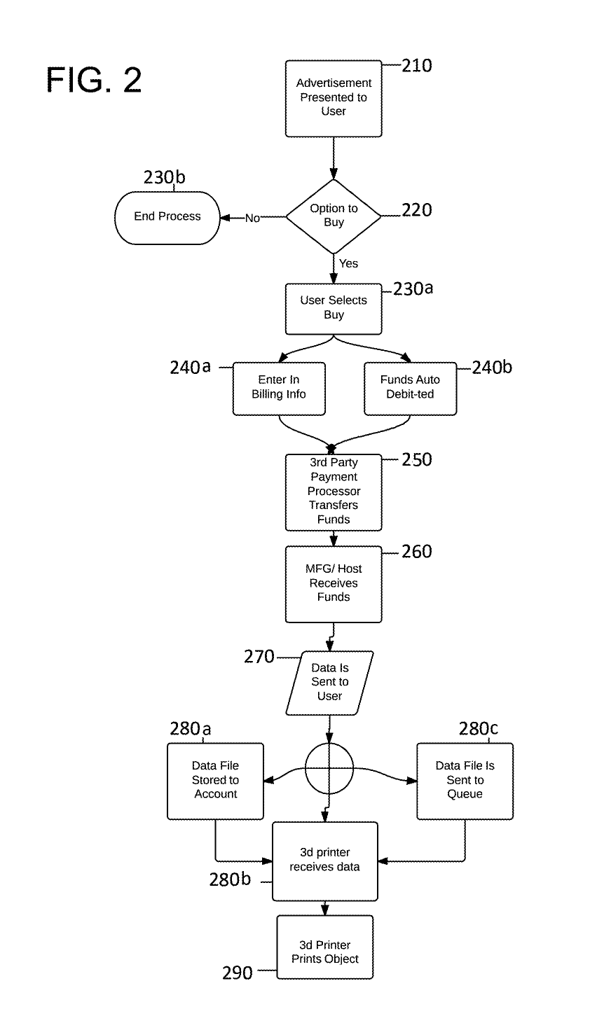

Turning next to FIG. 2, which illustrates essentially the same structure as FIG. 1, except without the preface of the user interacting with content as the beginning of the transaction. FIG. 2 illustrates that, as long as the customer witnesses the advertisement and proceeds with the purchase, the method is unaffected. The principal difference between the processes in FIGS. 1 and 2 resides in step 220b, in which the process ends rather than the user electing to return to the original content upon election by the user not to proceed with the purchase. The circumstances that initiate the transaction are based on the initiation by an unsolicited advertisement rather than the actions of the customer/user prior to initiation. FIG. 2 simply outlines other possible circumstances that can lead to initiation of a transaction. The 200-series numbers used to depict the steps in FIG. 2 correspond to the analogous step in FIG. 1 using the 100-series numbers.

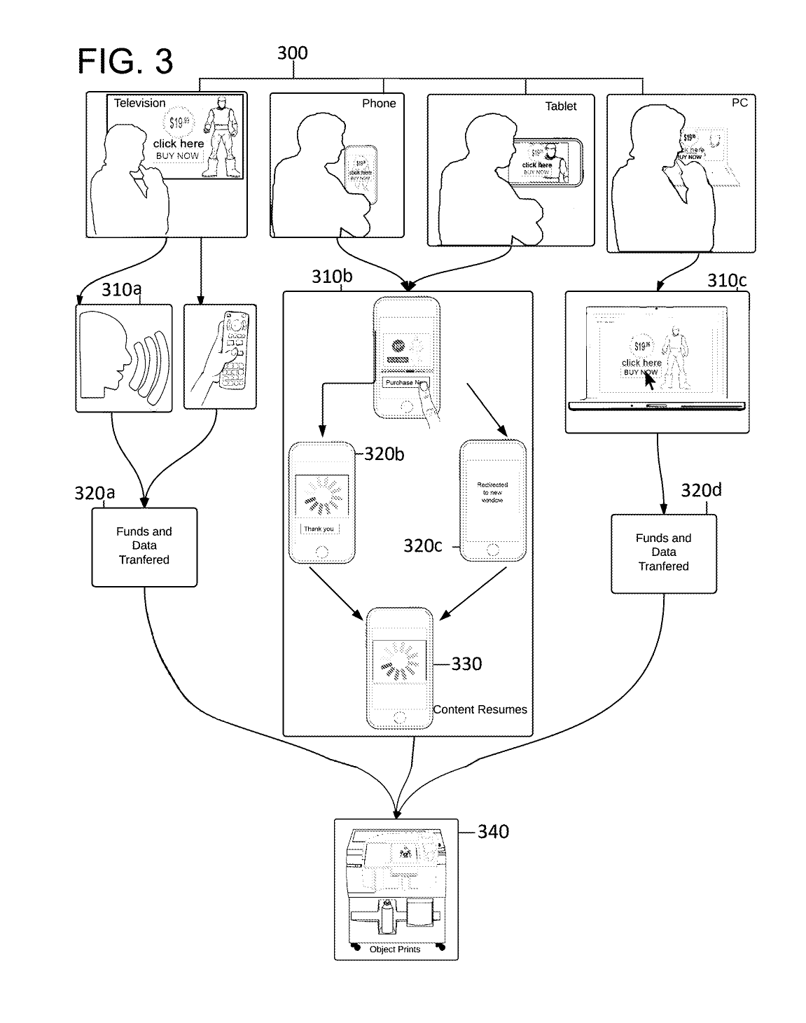

In FIG. 3, the consumer witnesses an advertisement for a specified object of objects from one of a number of media, through any number of smart technology devices (step 300), to include smart phones, tablets, personal computers, smart television sets, entertainment console and other suitable devices. The device is of a format that has smart capabilities. In step 300, the user is first influenced to interact with the advertisement by way of a link-based prompt option, such as, for example, by voice command, by touch screen or by clicking on the link, as depicted in steps 310a, 310b and 310c, respectively. The interaction will occur simultaneously or near-simultaneously through a third party payment processor designated at a prior time, or, if the seller elects not to outsource the payment process, they can handle their own payment processes (steps 320a, 320c and/or 320d); or the link will redirect the consumer to a third party link in which payment will be consummated methods including credit card, debit card, radio-frequency identification (RFID) based payment methods, online brokerage accounts, such as PayPal, or through a prepaid debit based account (step 320b). The transaction will be completed once payment has been rendered and the formatted file necessary or desirable for rendering the object as advertised has been exchanged, returning the customer to their previous content (step 330), as well as the transfer of data to the appropriate device, as outlined in FIG. 1 and FIG. 2, culminating in the rendering of the object (step 340).

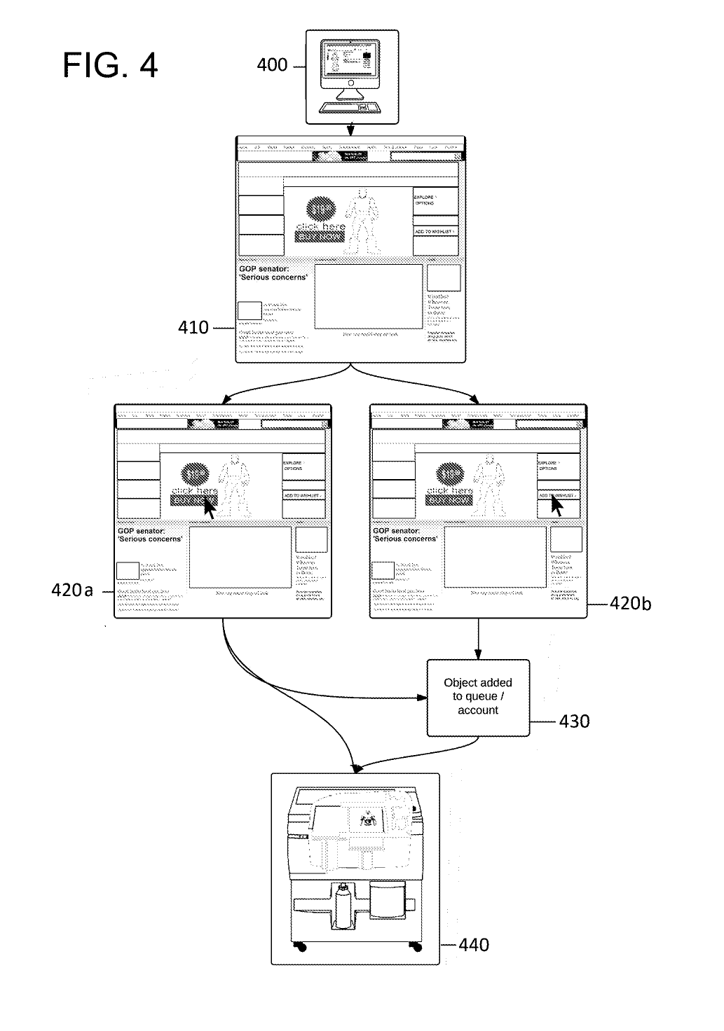

FIG. 4 depicts the graphical representation of the described embodiment, with the user interfacing a web portal for the present method and system. As in the previous figures, the user interacts with the content presented (step 400). However, unlike previously the steps set out in the previous figures, a static web advertisement is presented and witnessed by the user (step 410). The user chooses to initiate the process by choosing to purchase the item as shown in step 420a, or can elect to postpone the purchase for a later time or date by saving the choice in a shopping cart or stored customer wish list or another similar feature, as highlighted in step 420b. There is no option listed in FIG. 4 to return the user to the previous content as in the other figures, since in this example, there is not a deviation from the standard content through a dynamic advertisement such as a commercial, but instead the advertisement is incorporated into the layout of the content on the website or portal. Regardless of whether the advertisement is a dynamic advertisement, such as a commercial, or a static advertisement such as in a banner advertisement, the process is still applicable to unsolicited advertisements generally. With either option, the object can be rendered immediately (step 440) or sent into a queue to be manufactured at a later date or at the convenience of the customer (step 430).

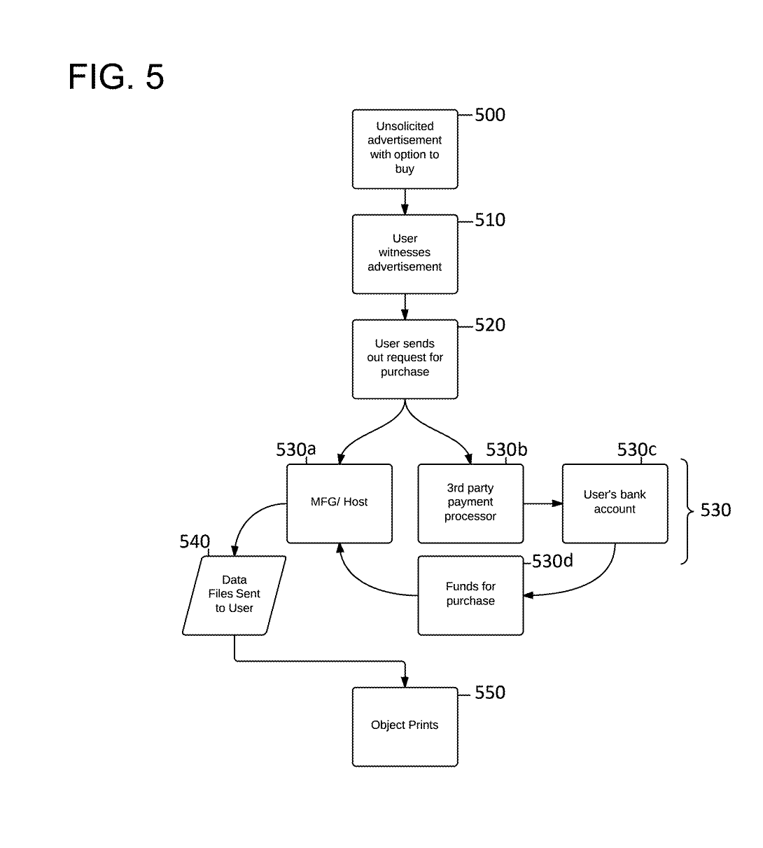

FIG. 5 shows how the economic cycle of the method works in a simplified fashion. There can be intermediaries, distributors and other parties that could be included; however those entities could each be represented by one of the three principal parties, namely, customer, third party processor and manufacturer/host. The customer first agrees to the terms of purchase and money can be debited to a third party processor or directly to the manufacturing host. The file will then be, upon successful payment, transmitted from the manufacturer to the customer in a digital format. Software or other means to facilitate the transfer, such as compression or encoding, would be considered a necessary or desirable part of the file transfer.

In FIG. 5, step 500 is the advertisement for an object to be rendered by a 3D printer. The user witnesses the advertisement (step 510) and subsequently issues a request for purchase (step 520) by initiating the transaction through the means described in previous figures such as by voice command, by touch screen or by clicking a link. The request is sent to the third party payment processor (step 530b), to confirm and transfer funds as to the practices and procedures accepted and allowed by standard fiduciary practices. The user's bank account, credit card company, or other financial account/payment institution (step 530c), is debited the funds for purchase in the amount of the sale price (step 530d), which is then transferred to the selling party (step 530a), who in turn sends the specified purchased data file to the user (step 540), who in turn renders the object at their convenience or enters it into a queue to be rendered at their convenience (step 550).

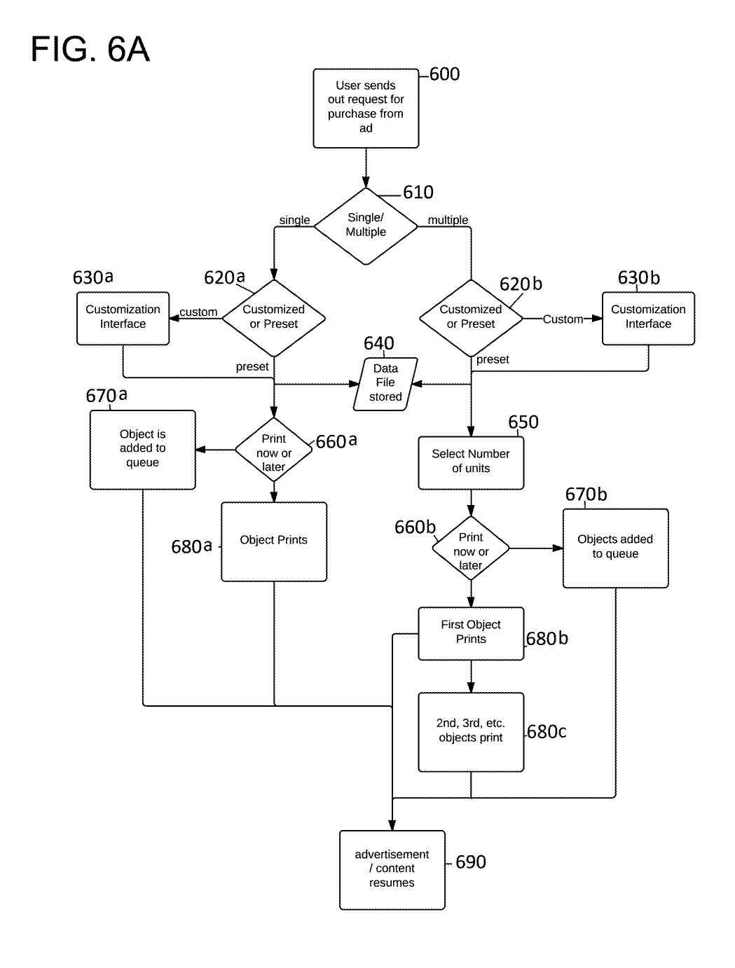

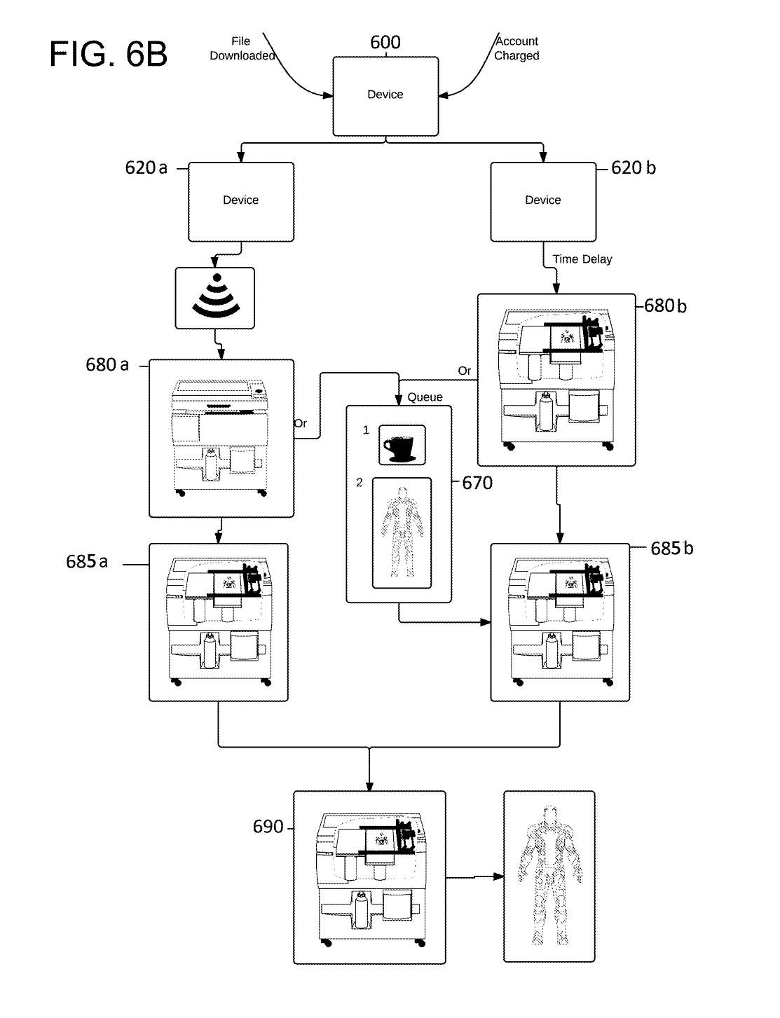

Upon completion of the transaction and the formatted file being transmitted to the buyer as depicted in the top portion of FIG. 6A. In step 600, the user sends a request for purchase by prompting the interaction through an interactive button or prompt within the advertisement. Step 610 delineates between a single file purchase and multiple file purchases, although it should be noted that multiple files does not necessarily mean multiple purchases, as one object may inherently require multiple components to function as designed and each file can be a single component of one overall object. In steps 620a and 620b, depending on whether the object falls into a classification of semi-standard, semi-custom or custom, the user can elect to customize the object to the predetermined presets or choices outlined by the seller within the prompt depending on the characteristics of the object. If the user elects to make the outlined choices or changes, they will be directed to an interface or menu, as depicted in steps 630a and 630b. If the user has an account in which preferences are stored or past purchases are tracked, the modifications or changes in the prior steps may or may not be saved by the seller or buyer as depicted in step 640.

As further shown in FIG. 6A, the object will either be simultaneously or near-simultaneously downloaded and, if the device is synchronized with the 3D printer, the object will be rendered immediately or after a length of time between any of the foregoing steps (steps 660a, 670a and step 680a), which can be resumed at the convenience of the user/buyer or when the file has been properly transferred from the device in which the purchase occurred to the 3D printer, whether it be direct or through intermediate devices, or from the cloud-based server from which the file can be downloaded. The file can be immediately downloaded or retained in a queue structure in which it will await manufacture. If multiple objects are ordered in one transaction, step 650 would allow the user to purchase multiple files in one transaction. If multiple files are to be downloaded to create multiple parts or components for a single object, step 650 would be skipped, but the process with multiple files would still be followed.

In FIG. 6A, step 660b depicts the choice given to the customer upon download of the file(s). The customer can elect to print the object immediately (step 680b), or direct the object into a queue (step 670b) to initiate rendering of the object at the convenience of the customer. During a multiple component rendering, step 680c depicts the multiple components or multiple files subsequently being rendered. In step 690, the user returns to the content previously accessed prior to the purchase following a successful transaction.

FIG. 6B illustrates the file being downloaded to the software or 3D printing device following the customer's account being charged, as depicted in step 600. Step 620a and 620b depict wireless sync and a time delayed manual sync, respectively, the latter through hardware such as a thumb-drive, flash-drive, or other external storage device, the file being transferred either to the printer directly or to a software interface that controls the printing, depending on the parameters and function of the device itself. The 3D printing device receives the files, as depicted in steps 680a and 680b, where the file either enters a queue, as in step 670, or begins rendering the object from the file immediately as depicted in steps 685a) and 685b. Upon final completion of the object printing (step 690), the process in finished. Although the transaction is completed following the transfer of funds from buyer to seller, and the file from seller to buyer, the process is deemed to be complete upon the final rendering of the object by the user/customer.

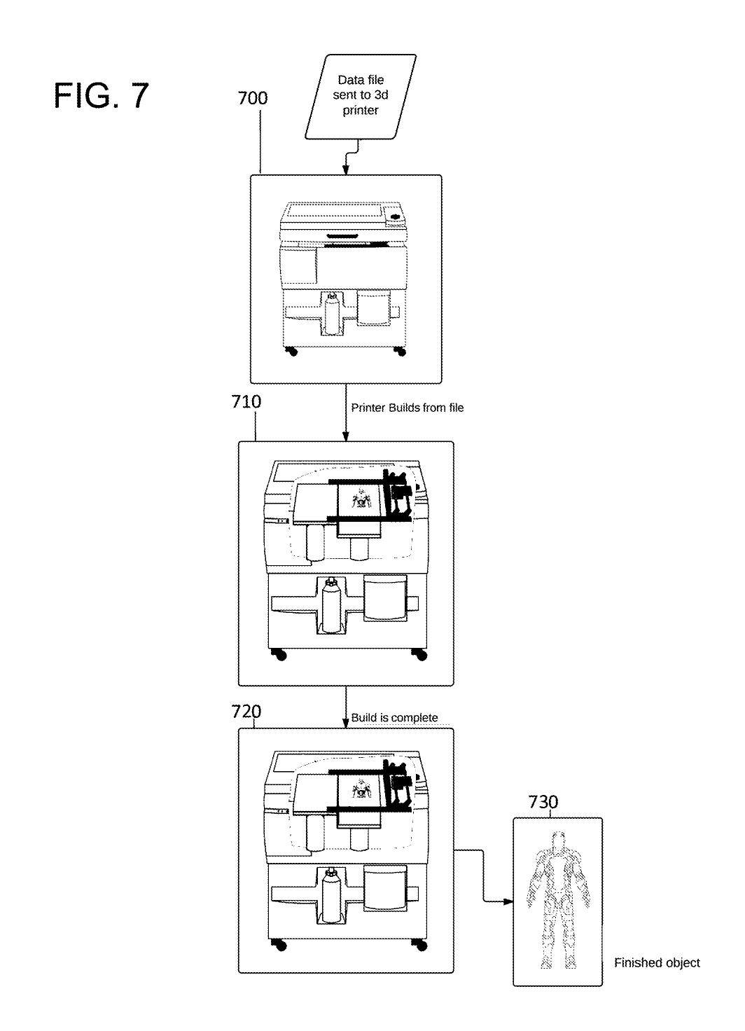

FIG. 7 shows that once the file is downloaded to the software controlling the 3D printer, it can be rendered based on the printer manufacturer's specifications and other variables that will affect the time and resources of the manufacturing process. Upon completion, the advertised object will be rendered within the user's home or business for the user's specified use. FIG. 7 depicts the object rendering process. The steps cover the data being sent to the device (step 700), to where the building begins (step 710), when manufacturing is complete (step 720), and the object is finished and ready for use (step 730).

While particular elements, embodiments and applications of the present invention have been shown and described, it will be understood, that the invention is not limited thereto since modifications can be made by those skilled in the art without departing from the scope of the present disclosure, particularly in light of the foregoing teachings.

1. A system for forming a physical object from a digital file generated from a transaction carried out on an internet enabled device, the system comprising:
(a) an internet enabled device capable of receiving an unsolicited advertised offer and transmitting communications from a user regarding a purchase based upon said advertised offer;
(b) a digital rendering device capable of forming a physical object from a digital file containing user specified instructions;
(c) a vendor capable of receiving information regarding said purchase and providing said digital file in a downloadable format;
(d) a payment processor capable of (i) receiving monetary funds transfer authorization from said user, (ii) effecting said monetary funds transfer, (iii) issuing a communication to said vendor when said monetary funds transfer is successfully effected, and (iv) transferring at least a portion of said monetary funds to said vendor.

2. The system of claim 1, wherein said digital rendering device is a three-dimensional printer.

3. The system of claim 1, wherein said digital rendering device is an additive manufacturing device.

4. The system of claim 1, further comprising a data storage device capable of storing said digital file for a period of time until said user releases said digital file from said data storage device to commence formation of said physical object.

5. The system of claim 4, wherein said data storage device resides within said digital rendering device.

6. The system of claim 4, wherein said data storage device is cloud-based.

7. The system of claim 4, wherein said digital file is sequenced with other digital files to commence formation of said physical object once other physical objects have been formed using said other digital files.

8. A method of forming a physical object from a digital file generated from a transaction carried out on an internet enabled device, the method comprising:
(a) receiving an unsolicited advertised offer from a vendor on an internet enabled device;
(b) transmitting communications from a user regarding a purchase based upon said unsolicited advertised offer;
(c) receiving authorization from said user for the transfer of monetary funds;
(d) effecting said monetary funds transfer;
(e) issuing a communication to said vendor when said monetary funds transfer is successfully effected;
(f) providing said digital file in a downloadable format to said user;
(g) delivering said digital file to digital rendering device;
(h) effecting formation of a physical object by said digital rendering device using instructions contained in said digital file;
(i) transferring at least a portion of said monetary funds to said vendor.

9. The method of claim 8, wherein said digital rendering device is a three-dimensional printer.

10. The method of claim 8, wherein said digital rendering device is an additive manufacturing device.

11. The method of claim 8, further comprising storing said digital file in a data storage device for a period of time until said user releases said digital file from said data storage device to commence formation of said physical object.

12. The method of claim 11, wherein said data storage device resides within said digital rendering device.

13. The method of claim 11, wherein said data storage device is cloud-based.

14. The method of claim 11, further comprising sequencing said digital file with other digital file to commence manufacture of said physical object once other physical objects have been manufactured using said at least some of said other digital files.

15. The method of claim 8, wherein said internet enabled device is a digital display.

16. The method of claim 15, wherein said advertised offer occurs during an entertainment session on a digital display.

17. A method of forming a physical object from a digital file generated from a transaction carried out on an internet enabled device, the method comprising:
(a) receiving an unsolicited advertised offer from a vendor on an internet enabled device;
(b) transmitting communications from a user regarding a purchase based upon said unsolicited advertised offer;
(c) receiving authorization from said user for the transfer of monetary funds;
(d) effecting said monetary funds transfer;
(e) issuing a communication to said vendor when said monetary funds transfer is successfully effected;
(f) providing said digital file in a downloadable format to said user;
(g) delivering said digital file to digital rendering device;
(h) effecting formation of a physical object by said digital rendering device using instructions contained in said digital file;
(i) transferring at least a portion of said monetary funds to said vendor,
wherein said internet enabled device is a digital display,
wherein said advertised offer occurs during an entertainment session on said digital display, and
wherein said physical object is a miniature thematic figurine.

18. A method of forming a physical object from a digital file generated from a transaction carried out on an internet enabled device, the method comprising:
(a) receiving an unsolicited advertised offer from a vendor on an internet enabled device;
(b) transmitting communications from a user regarding a purchase based upon said unsolicited advertised offer;
(c) receiving authorization from said user for the transfer of monetary funds;
(d) effecting said monetary funds transfer;
(e) issuing a communication to said vendor when said monetary funds transfer is successfully effected;
(f) providing said digital file in a downloadable format to said user;
(g) delivering said digital file to digital rendering device;
(h) effecting formation of a physical object by said digital rendering device using instructions contained in said digital file;
(i) transferring at least a portion of said monetary funds to said vendor,
wherein said internet enabled device is a digital display,
wherein said advertised offer occurs during an entertainment session on said digital display, and
wherein said physical object is edible.

19. The method of claim 8, further comprising:
allowing said user to choose a customizable option on said digital file, wherein said customizable option effects a feature of said physical object.

20. A method of forming a physical object from a digital file generated from a transaction carried out on an internet enabled device, the method comprising:
(a) receiving an unsolicited advertised offer from a vendor on an internet enabled device;
(b) transmitting communications from a user regarding a purchase based upon said unsolicited advertised offer;
(c) receiving authorization from said user for the transfer of monetary funds;
(d) effecting said monetary funds transfer;
(e) issuing a communication to said vendor when said monetary funds transfer is successfully effected;
(f) providing said digital file in a downloadable format to said user;
(g) delivering said digital file to digital rendering device;
(h) effecting formation of a physical object by said digital rendering device using instructions contained in said digital file;
(i) allowing said user to choose a customizable option on said digital file, wherein said customizable option effects a feature of said physical object;
(j) transferring at least a portion of said monetary funds to said vendor, and
wherein said physical object is a miniature thematic figurine.
